(19) United States
(12) Patent Application Publication
(10) Pub. No.: US 2008/0159253 A1
(43) Pub. Date: Jul. 3, 2008

(54) METHOD TO INCREASE LINK QUALITY IN MULTIHOP SYSTEM

(75) Inventors: Junya YAMAZAKI, Moriya-Shi (JP); Mohsin M. Mollah, Chiba-Shi (JP)

Correspondence Address: PRASS & IRVING LLP, 2661 Riva Road, Bldg. 1000, Suite 1044, ANNAPOLIS, MD, 21401, US

(73) Assignee: Motorola, Inc., Schaumburg, IL (US)

(21) Appl. No.: 11/617,748

(22) Filed: Dec. 29, 2006

(51) Int. Cl. H04B 7/212

(52) U.S. Cl. 370/347

(57) ABSTRACT

A method, apparatus, and electronic device for improving link quality in a multihop system are disclosed. The method may include reading with a mobile system a first transmission between a base system and a first relay system; reading with the mobile system a second transmission of an altered first transmission between the first relay system and the mobile system; and combining the first transmission and the second transmission to produce a first signal.

### BACKGROUND OF THE INVENTION

1. Field of the Invention

The present invention relates to a method and system for increasing link quality in a multihop system. The present invention further relates to combining signals read from a base system and a relay system.

2. Introduction

A greater portion of the population than in even the recent past has adopted wireless technology to service their communication needs. This increased penetration of the market is due to wireless communications ability to increase the mobility of the user and increase the access of these users. Homes and offices have switched from having wired local area networks (LAN) to wireless LANs that allow for a number of computers to be interconnected at a fraction of the cost and upkeep. In telephony, most people of the younger generations have foregone the use of landlines in the home in favor of cellular technology that allows them to keep in greater contact with their peers at a fraction of the cost. This trend is even more pronounced outside the United States, where the cellular technology has greater penetration due to more congested land use and lack of costly landline infrastructure.

This wireless revolution is not without its drawbacks. Wireless communication is basically unstable. Techniques such as forward error correction, retransmission, and many others are employed to improve reliability of communication. To gain a reliability of communication, using more resources like transmission power or wide frequency band is one of the solutions. However, using transmission power and frequency band comes with its own limitations. More robust link quality is a constant issue in wireless communications. The same is true for the relay communication environment. Thus, techniques that are more effective than the conventional wireless systems are needed.

### SUMMARY OF THE INVENTION

A method, apparatus, and electronic device for improving link quality in a multihop system are disclosed. The method may include reading with a mobile system a first transmission between a base system and a first relay system; reading with the mobile system a second transmission of an altered first transmission between the first relay system and the mobile system; and combining the first transmission and the second transmission to produce a first signal. Additionally, the method may be used for uplink communication as well as downlink communication, with the base system reading transmissions from both the mobile system and the relay station.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates the basic function of a relay station.

FIG. 2 illustrates in a block diagram a multihop relay system for wireless communications.

FIGS. 3a-b illustrate in a block diagram methods of error correction.

FIGS. 4a-b illustrate embodiments of multihop systems using the present invention.

FIGS. 5a-b illustrate attenuated and optimum localities for the present invention.

FIG. 6 illustrates in a block diagram one embodiment of a base station.

FIG. 7 illustrates in a block diagram one embodiment of a relay station.

FIG. 8 illustrates in a block diagram one embodiment of a mobile system.

FIG. 9 illustrates in a block diagram one embodiment of a relay station with an altered modulation process.

FIGS. 10a-d illustrate one embodiment of constellation change in the present invention.

FIG. 11 illustrates in a graph a comparison of hybrid automatic repeat request characteristics chase combining and constellation change

FIG. 12 illustrates one embodiment of a method for a puncture pattern change.

FIG. 13 illustrates in a trellis chart used in Viterbi soft decoder puncture pattern decoding.

FIG. 14 illustrates in a graph the comparison between chase combining and incremental redundancy.

FIG. 15 illustrates a possible configuration of a computer system to act as a mobile system, relay system, or base station to execute the present invention.

### DETAILED DESCRIPTION OF THE INVENTION

Additional features and advantages of the invention will be set forth in the description which follows, and in part will be obvious from the description, or may be learned by practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth herein.

Various embodiments of the invention are discussed in detail below. While specific implementations are discussed, it should be understood that this is done for illustration purposes only. A person skilled in the relevant art will recognize that other components and configurations may be used without parting from the spirit and scope of the invention.

The present invention comprises a variety of embodiments, such as a method, an apparatus, and an electronic device, and other embodiments that relate to the basic concepts of the invention. The electronic device may be any manner of mobile device, relay station or other wireless communication device.

A method, telecommunication apparatus, and electronic device for improving link quality in a multihop system are disclosed. A mobile system may read a first transmission between a base system and a first relay system. The mobile system may read a second transmission of an altered first transmission between the first relay system and the mobile system. The mobile system may then combine the first transmission and the second transmission to produce a first signal. The first transmission may be altered using constellation change, puncture pattern change, changes to the randomizer, and changes to the interleaver bit.

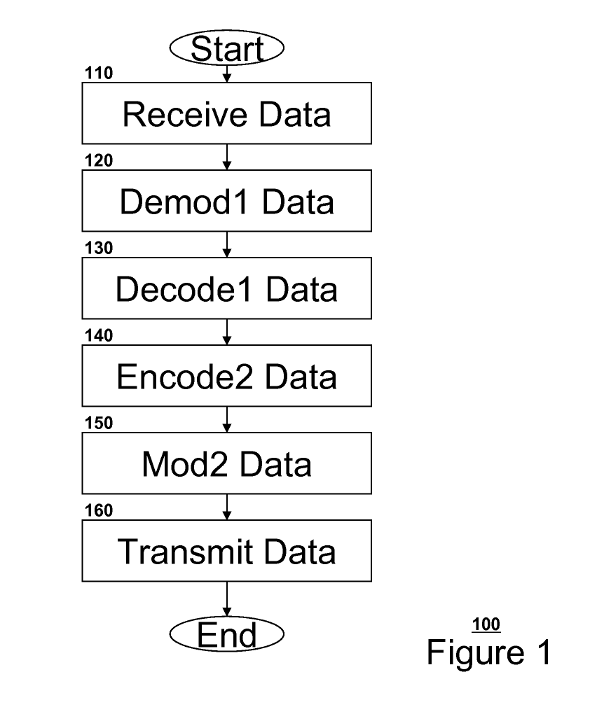

The use of relay stations may be used to improve link quality. FIG. 1 illustrates the basic function 100 of a relay station. The relay station receives the data from a first remote unit on a first set of frequencies (Block 110). The relay station demodulates the date using a first demodulation technique (Block 120). The relay station decodes the data using a first decoding technique (Block 130). The relay station encodes the data using a second encoding technique (Block 140). The relay station demodulates the date using a second modulation technique (Block 150). The relay station transmits the data to a second remote unit on a second set of frequencies (Block 160).

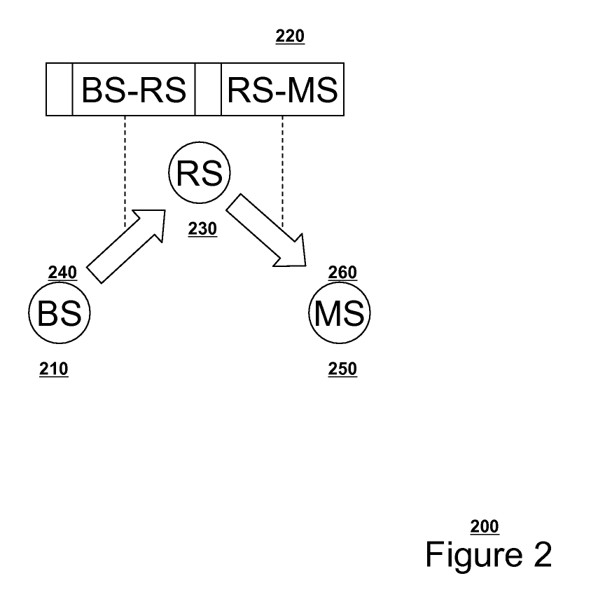

FIG. 2 illustrates in a block diagram a multihop relay system 200 for wireless communications. A base station 210 sends a downlink frame 220 to a relay station 230 over a relay link 240. The relay station 230 retransmits the downlink frame 220 to a mobile station 250 over an access link 260. The relay link 240 transmission time may be different from that of the access link 260.

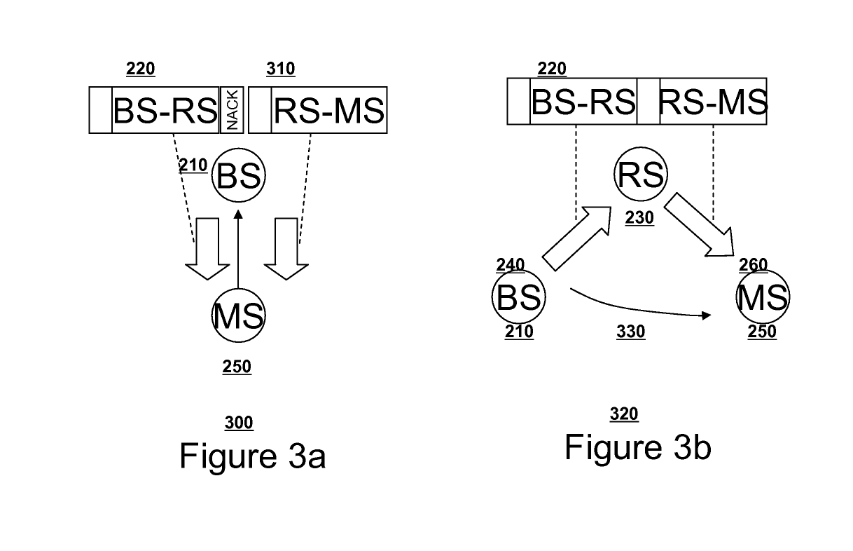

FIG. 3a illustrates in a block diagram a method 300 of hybrid automatic repeat request (HARQ). The base station 210 transmits a downlink frame 220 to the mobile station 250. If the mobile station 250 fails to receive the data correctly, the mobile station transmits a negative acknowledgment 310 to the base station 210. The base station 210 transmits data to the mobile station 250 again. The mobile station may combine the first received data and the second received data. If the transmitted symbol was the same, the method used is referred to as Chase combining, or HARQ.

FIG. 3b illustrates in a block diagram a combination signal check 320 using the “eavesdropping” signal 330 between the base 210 and the relay station 230. The mobile station 250 receives two transmissions from the base station 210 and the relay station 230. The timing differential for each signal will be different. Normally received power from the base station 210 transmission is not stronger than the received power from the relay station 230. The mobile station 250 may still combine the signals.

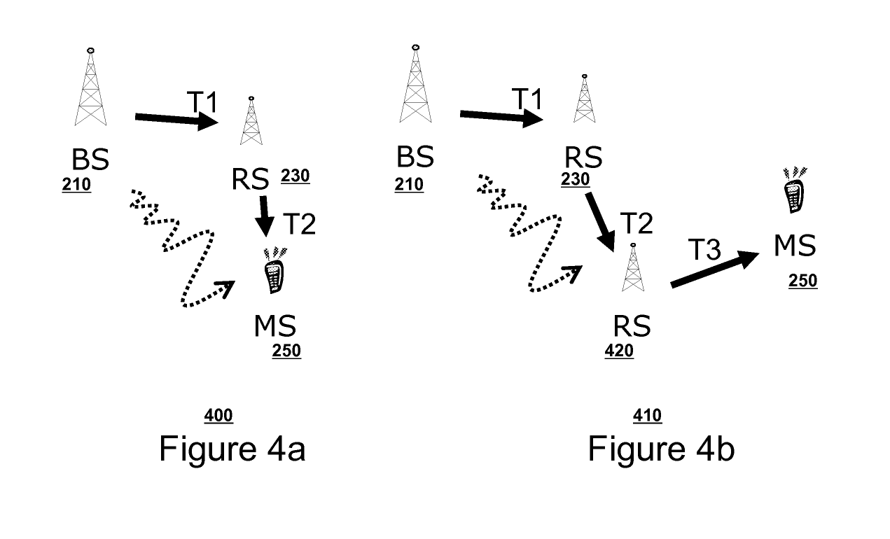

FIG. 4a illustrates an embodiment 400 in which the mobile relay station 250 is combining the base station 210 transmissions and the relay station 230 transmissions. FIG. 4b illustrates an embodiment 410 in which a second relay station 420 is combining the base station 210 transmissions and the relay station 230 transmissions. Additionally, the base station may apply the method as well for uplink situations.

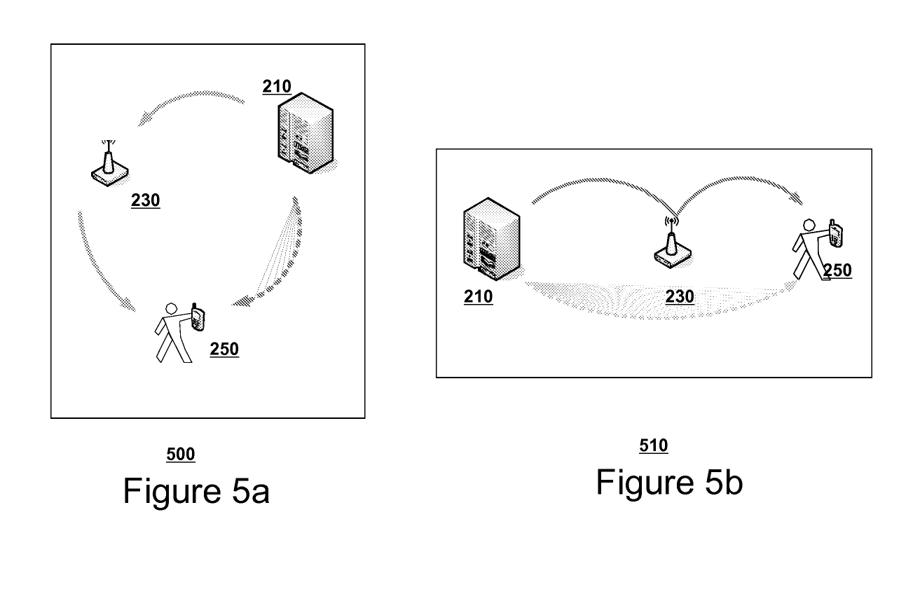

As shown by FIG. 5a, this combination method is optimum when the receiving powers from the relay station 230 and the base station 210 are similar. FIG. 5b shows that the eavesdropping signal becomes attenuated the farther the mobile system 250 becomes from the base 210. At the optimum locality 500, the receiving power may double. The gain from the added power and the time diversity may be over 3 dB. At the attenuated locality 510, the additive receiving power and the better performance would be unexpected because the distance from the base 210 to the mobile system 250 is too far.

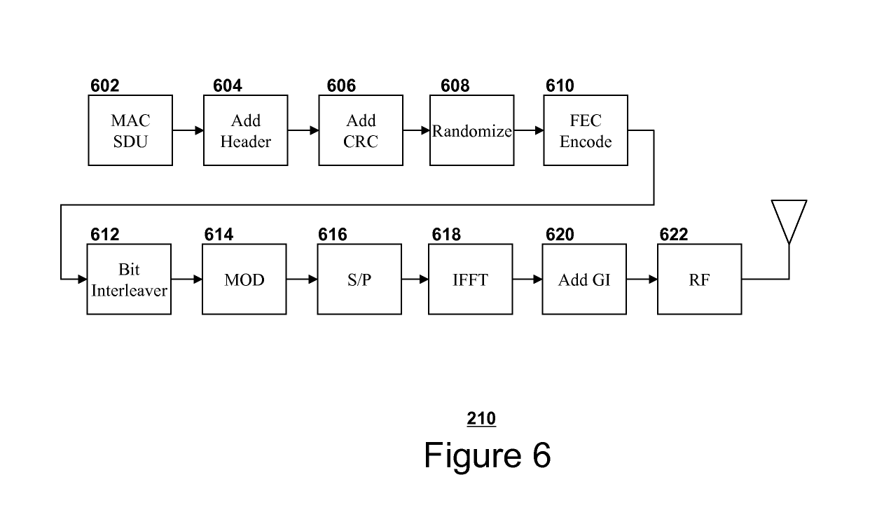

FIG. 6 illustrates in a block diagram one embodiment of a base station 210. A media access control (MAC) service data unit (SDU) 602 may provide a data signal to be transmitted. A header block 604 may add a header to the data signal to provide information about the data being transmitted, including kinds of data, control, transport data, and other information. A cyclical redundancy check (CRC) encoder 606 may add a CRC to the data signal as a method of checking the reliability of the data being transmitted. A randomizer 608 may randomize (or apply a randomized pattern change) the data for transmission signal equality. A forward error correction (FEC) encoder 610 may encode the data with FEC. A bit interleaver 612 may order change the bits (or bit interleave) to strengthen against the signal fading. A modulator 614 may modulate the bits to the wave for transmission. A serial-to-parallel (STP) converter 616 may convert the data stream from serial to parallel. An inverse fast Fourier transform (IFFT) block 618 may apply an IFFT 618 to the data stream to convert it from a time domain to a frequency domain. A guard interval (GI) block 620 may add a guard interval to counteract any delayed waves. The antenna of the base station transmitter 622 may transform the signal from a lower frequency to a higher frequency and transmit the signal over a radio frequency.

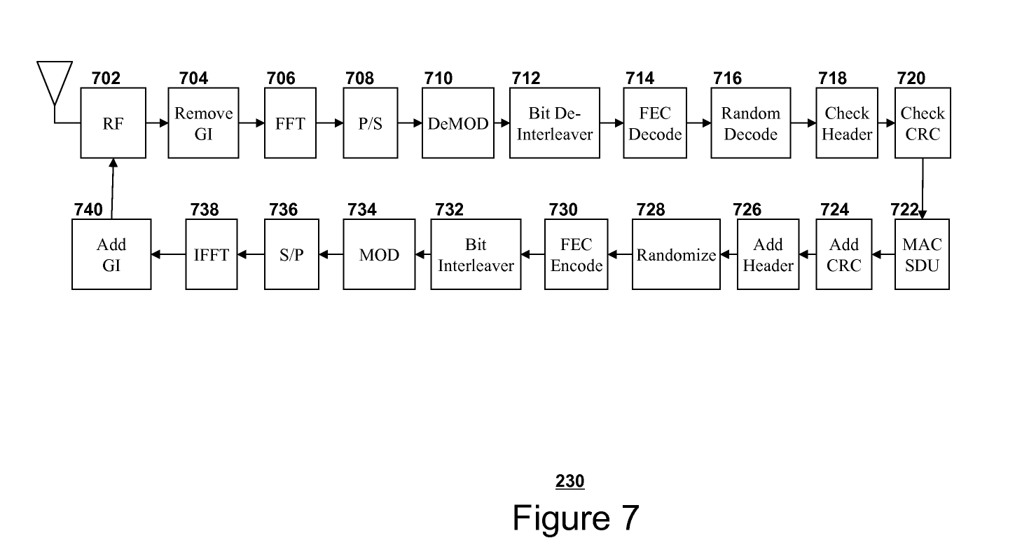

FIG. 7 illustrates in a block diagram one embodiment of a relay station 230. The radio frequency antenna of the receiver 702 may receive a signal and adjust from a higher frequency to a lower frequency. A GI block 704 may remove the GI to remove redundant data. A fast Fourier transform (FFT) block 706 may apply a FFT to convert the signal from the frequency domain to the time domain. A parallel-to-serial (PTS) converter 708 may convert the signal from parallel to serial. A demodulator 710 may demodulate the signal, with the wave mapping to each bit. A bit deinterleaver 712 may bit deinterleaver the signal to reorder to the bit. A FEC decoder 714 may decode and check the FEC. A randomizer 716 may decode the randomized part of the signal. A header block 718 may check the header. A CRC decoder 720 may decode and check the CRC. The relay station 230 may store the data as MAC SDU 722.

As with the base station 210, a MAC SDU 722 may provide a data signal to be transmitted. A header block 724 may add the header. A CRC encoder 726 may add a CRC to the data signal. A randomizer 728 may randomize the data bit. The FEC encoder 730 may FEC encode the data. A bit interleaver 732 may order change the bits. A modulator 734 may modulate the data for transmission. A STP converter 736 may convert the data stream from serial to parallel. An IFFT block 738 may apply an IFFT to the data stream. A GI block 740 may add a GI. The relay station 230 may then transmit the signal over the radio frequency transmitter 702.

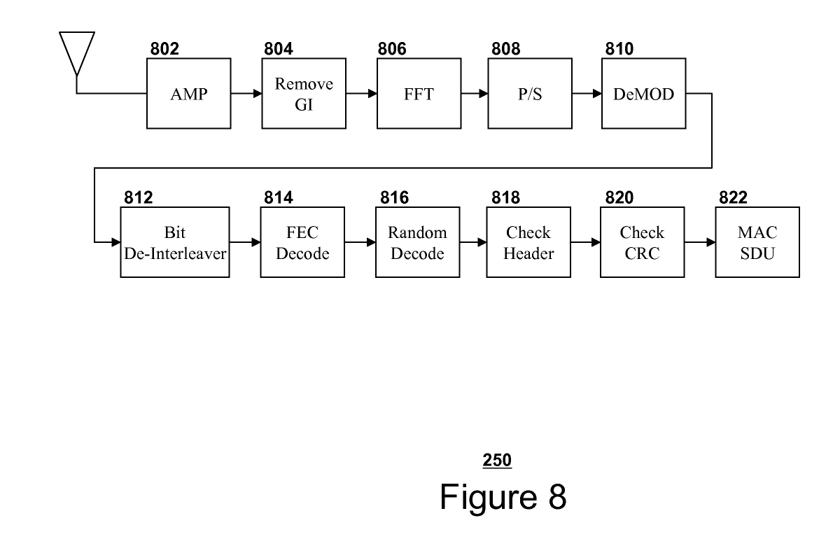

FIG. 8 illustrates in a block diagram one embodiment of a mobile system 250. As with the relay station 230, the radio frequency antenna of the receiver 802 may receive a signal and amplify it. A GI block 804 may remove a GI. A FFT block 806 may apply a FFT to convert the signal from the frequency domain to the time domain. A PTS converter 808 may convert the signal from parallel to serial. A demodulator 810 may demodulate the signal. A bit deinterleaver 812 may bit deinterleave the signal. A FEC encoder 816 may decode and check the FEC 816. A randomizer 818 may decode the randomized part of the signal. A header block 818 may check the header. A CRC decoder 820 may decode and check the CRC. The data is stored as MAC SDU 822.

When the relay station 230 relays data, the relay station 230 may change transmission power or FEC method, like adaptive modulation coding (AMC) or puncture rate, to avoid interference or to place a link adaptation. However, the relay station 230 does not change transmission patterns, such as FEC (like convolutional code or turbo code) and puncture patterns, because changing FEC does not effect favorably on the next stations directly.

The transmission patterns may be changed to obtain more diversity gain. Diversity gain obtained in the combination is different from quadrature amplitude modulations (QAM) symbol positions. The transmission patterns may be changed when the symbol pattern and constellation are same or similar in the relay link and the access link. The transmission patterns may be changed at either the modulation block (constellation mapping change) 734, the FEC encoding block (puncture pattern change) 730, the bit interleaver 732, or the randomizer 728.

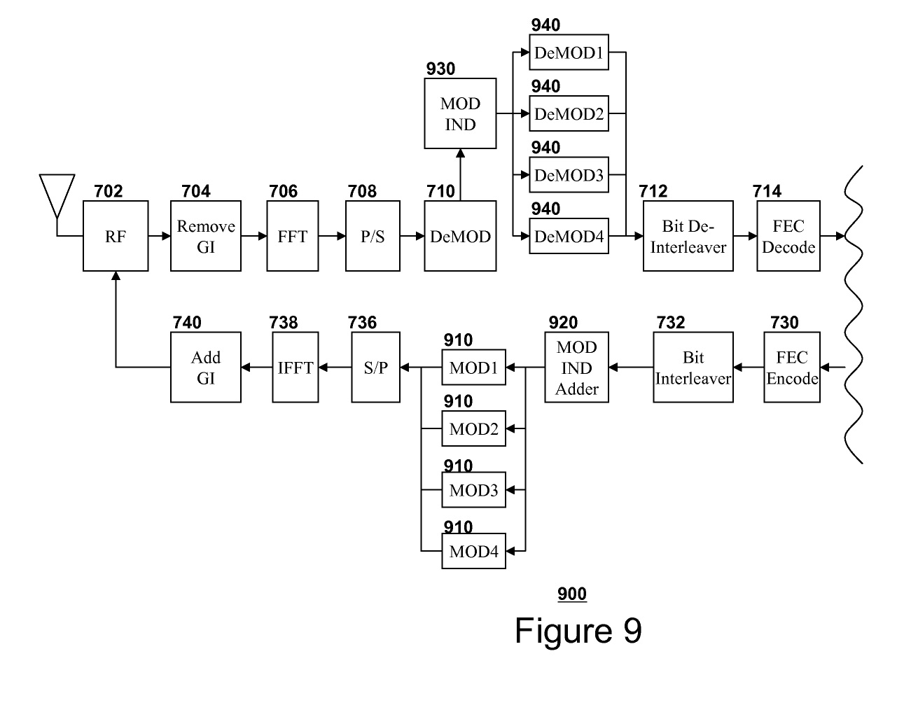

FIG. 9 shows some of the changes made to the modulation process 900. One of a number of modulation processes 910 may be used. A modulation indication is added 920 to indicate to the subsequent receivers which modulation process was used. Similarly, for the demodulation process, the modulation indicator 930 is read. The indicated demodulation process 940 is then used to demodulate the data.

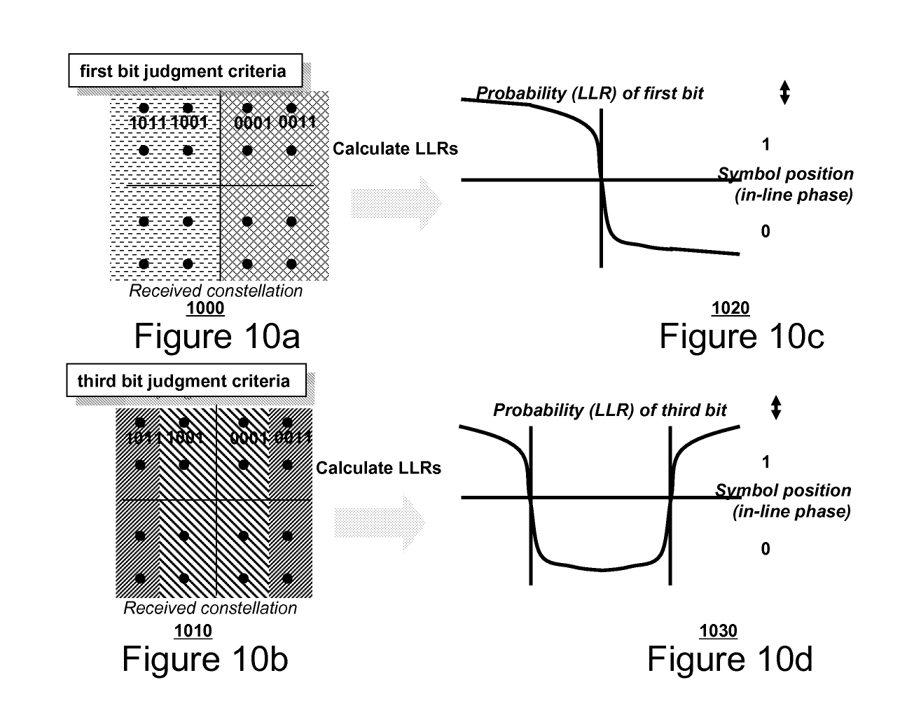

FIGS. 10a-d illustrate one embodiment of constellation change 1000 in the present invention. FIGS. 10a-b show symbol mapping of 16 QAM and symbol judgment criteria of each bit. FIGS. 10c-d show the graph of log likelihood ratio (LLR) for those bits. One symbol judgment criteria line divides dashed and cross-hatched parts in FIG. 10a for a first bit judgment criterion. Two symbol judgment criteria lines divide right-slanted-line and left-slanted-line parts in FIG. 10b for a third bit judgment criteria. This means the probability of error happening is quite different between the first bit and the third bit in QAMs. Additionally, a symbol with too high peak power falls on the right end or left end. This means that a symbol with too strong a power will make the value LLR higher but too weak a power will have no major effects. To average this disproportion, the constellations may be interchanged in the each hop, making the relay route tougher. A constellation-changing indicator may be attached in the physical (PHY) layer. This method will be effective when it is adopted with Chase combining.

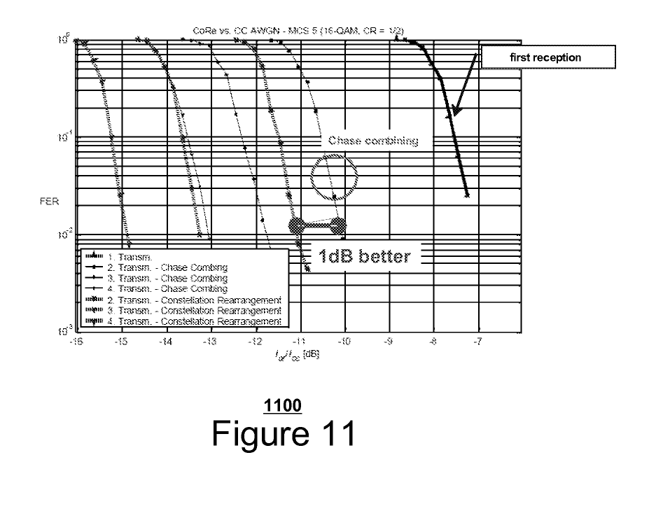

FIG. 11 shows HARQ characteristics chase combining and constellation change 1100. The chase combining corresponds to the combination in the relay. The constellation change corresponds to the proposed method in the relay. HARQ method is compared in a cellular parameter setting. The best situation in the relay case is assumed when the mobile system 250 receives two transmissions, and the gain will be about 1 dB in the situation. If mobile system 250 receives more than two transmissions, mobile system 250 is able to get more gain.

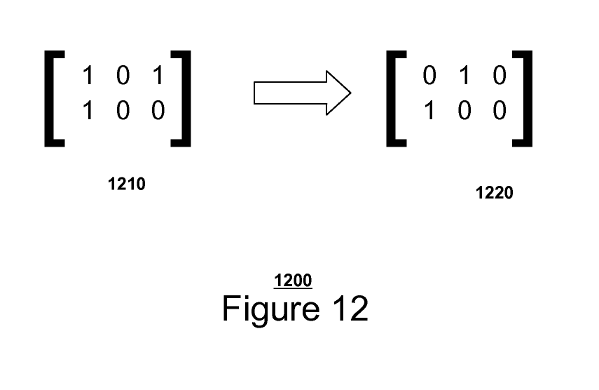

FIG. 12 illustrates one embodiment of a method 1200 for a puncture pattern change. The initial puncture pattern 1210 of the transmission is inverted 1220 when the puncture pattern is added during FEC encoding 730. Puncturing is a way of transmission symbol reduction that is increased by FEC. Puncturing is adapted for convolutional coding or turbo coding. Retransmission with puncture patterns is named incremental redundancy (IR) in a HARQ method. A puncture pattern indicator may be included on the relaying signals to alert downstream stations of the change in puncture pattern.

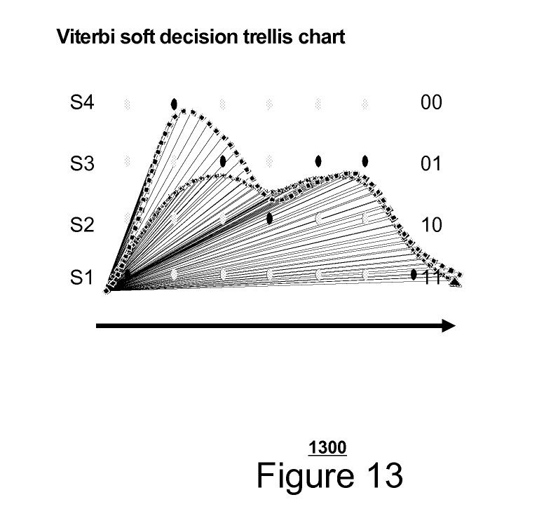

FIG. 13 illustrates in a trellis chart used in Viterbi soft decoder puncture pattern decoding 1300. Symbols S1-S4 are symbols that are correctly received. Viterbi decoding is to find the correct route by increasing the accuracy of the symbol. Chase combining may be used as the error recovery calculation method to fill the gap between the black points.

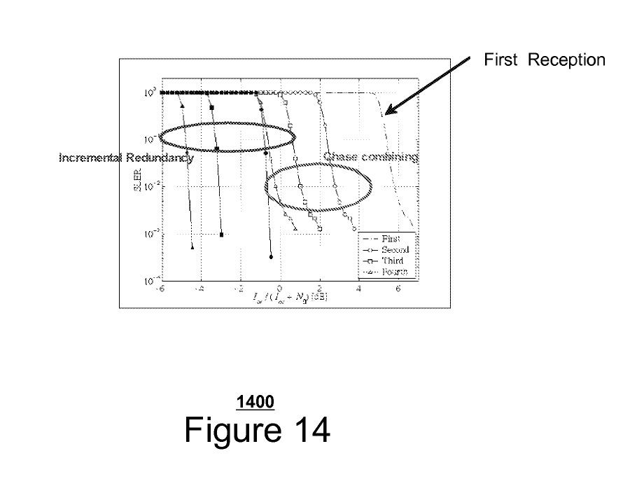

FIG. 14 illustrates in a graph the comparison 1400 between chase combining and IR. Corresponding to a relay station 230 environment, chase combining applies to relay link combination, and IR applies to puncture pattern change. A maximum difference of 3 dB is detected. Three radio wave combinations also make more gain than two radio wave combinations. This gain difference indicates that changing puncture pattern in every transmission is effective.

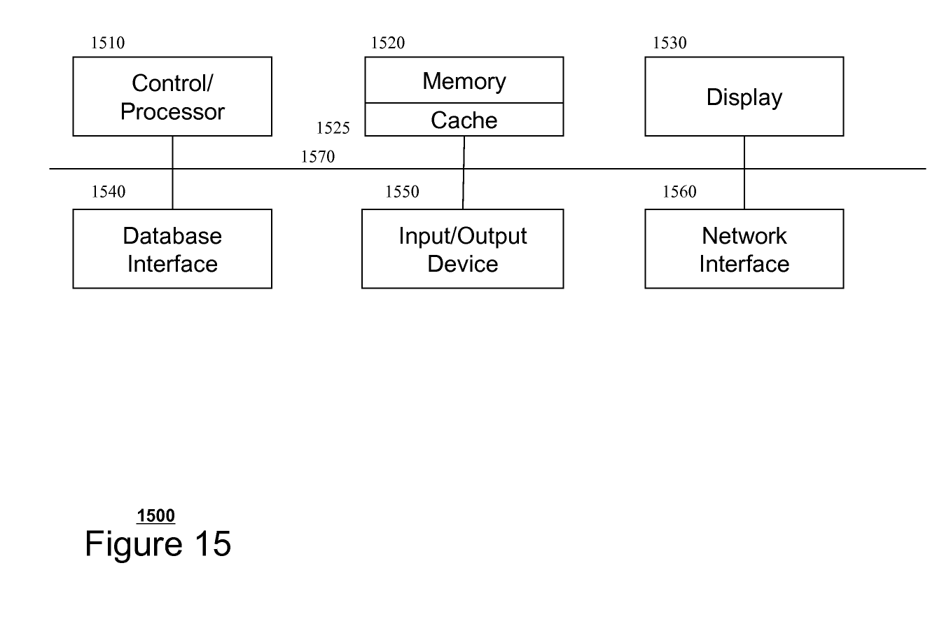

FIG. 15 illustrates a possible configuration of a computer system 1500 to act as a mobile system, relay system, or base station to execute the present invention. The computer system 1500 may include a controller/processor 1510, a memory 1520 with a cache 1525, display 1530, database interface 1540, input/output device interface 1550, and network interface 1560, connected through bus 1570.

The controller/processor 1510 may be any programmed processor known to one of skill in the art. However, the decision support method can also be implemented on a general-purpose or a special purpose computer, a programmed microprocessor or microcontroller, peripheral integrated circuit elements, an application-specific integrated circuit or other integrated circuits, hardware/electronic logic circuits, such as a discrete element circuit, a programmable logic device, such as a programmable logic array, field programmable gate-array, or the like. In general, any device or devices capable of implementing the decision support method as described herein can be used to implement the decision support system functions of this invention.

The memory 1520 may include volatile and nonvolatile data storage, including one or more electrical, magnetic or optical memories such as a RAM, cache, hard drive, CD-ROM drive, tape drive or removable storage disk. The memory may have a cache 1525 to speed access to specific data.

The Input/Output interface 1550 may be connected to one or more input devices that may include a keyboard, mouse, pen-operated touch screen or monitor, voice-recognition device, or any other device that accepts input. The Input/Output interface 1550 may also be connected to one or more output devices, such as a monitor, printer, disk drive, speakers, or any other device provided to output data.

The network interface 1560 may be connected to a communication device, modem, network interface card, a transceiver, or any other device capable of transmitting and receiving signals over a network. The components of the computer system 1500 may be connected via an electrical bus 1570, for example, or linked wirelessly.

Client software and databases may be accessed by the controller/processor 1510 from memory 1520 or through the database interface 1540, and may include, for example, database applications, word processing applications, the client side of a client/server application such as a billing system, as well as components that embody the decision support functionality of the present invention. The computer system 1500 may implement any operating system, such as Windows or UNIX, for example. Client and server software may be written in any programming language, such as ABAP, C, C++, Java or Visual Basic, for example.

Although not required, the invention is described, at least in part, in the general context of computer-executable instructions, such as program modules, being executed by the electronic device, such as a general purpose computer. Generally, program modules include routine programs, objects, components, data structures, etc. that perform particular tasks or implement particular abstract data types. Moreover, those skilled in the art will appreciate that other embodiments of the invention may be practiced in network computing environments with many types of computer system configurations, including personal computers, hand-held devices, multi-processor systems, microprocessor-based or programmable consumer electronics, network PCs, minicomputers, mainframe computers, and the like.

Embodiments may also be practiced in distributed computing environments where tasks are performed by local and remote processing devices that are linked (either by hardwired links, wireless links, or by a combination thereof through a communications network.

Embodiments within the scope of the present invention may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Although the above description may contain specific details, they should not be construed as limiting the claims in any way. Other configurations of the described embodiments of the invention are part of the scope of this invention. For example, the principles of the invention may be applied to each individual user where each user may individually deploy such a system. This enables each user to utilize the benefits of the invention even if any one of the large number of possible applications do not need the functionality described herein. It does not necessarily need to be one system used by all end users. Accordingly, the appended claims and their legal equivalents should only define the invention, rather than any specific examples given.

We claim:

1. A method for improving link quality in a multihop system, comprising:
reading with a mobile system a first transmission between a base system and a first relay system;
reading with the mobile system a second transmission of an altered first transmission between the first relay system and the mobile system; and
combining the first transmission and the second transmission to produce a first signal.

2. The method of claim 1, further comprising transmitting the first signal in a third transmission.

3. The method of claim 1, wherein the relay station applies a constellation mapping change to the first transmission to create the second transmission.

4. The method of claim 1, wherein the relay station applies a puncture pattern change to the first transmission to create the second transmission.

5. The method of claim 1, wherein the relay station applies a randomized pattern change to the first transmission to create the second transmission.

6. The method of claim 1, wherein the relay station applies bit interleave to the first transmission to create the second transmission.

7. A wireless telecommunications apparatus that receives signals in a multihop system, comprising:
a receiver that reads a first transmission between a base system and a first relay system and a second transmission of an altered first transmission between the first relay system and the wireless telecommunications apparatus; and
a processor that combines the first transmission and the second transmission to produce a first signal.

8. The wireless telecommunications apparatus of claim 7, further comprising a transmitter that transmits the first signal in a third transmission.

9. The wireless telecommunications apparatus of claim 8, further comprising a modulator that applies a constellation mapping change to the first transmission to create the second transmission.

10. The wireless telecommunications apparatus of claim 8, further comprising a forward error correction encoder that applies a puncture pattern change to the first transmission to create the second transmission.

11. The wireless telecommunications apparatus of claim 8, further comprising a randomizer that applies a randomized pattern change to the first transmission to create the second transmission.

12. The wireless telecommunications apparatus of claim 8, further comprising a bit interleaver that applies bit interleave to the first transmission to create the second transmission.

13. The wireless telecommunications apparatus of claim 7, wherein the relay station applies at least one of a constellation mapping change, a puncture pattern change, a randomizer pattern change, a bit interleave to the first transmission to create the second transmission.

14. An electronic device that receives signals in a multihop system, comprising:
a receiver that reads a first transmission between a base system and a first relay system and a second transmission of an altered first transmission between the first relay system and the electronic device; and
a processor that combines the first transmission and the second transmission to produce a first signal.

15. The electronic device of claim 14, further comprising a transmitter that transmits the first signal in a third transmission.

16. The electronic device of claim 15, further comprising a modulator that applies a constellation mapping change to the first transmission to create the second transmission.

17. The electronic device of claim 15, further comprising a forward error correction encoder that applies a puncture pattern change to the first transmission to create the second transmission.

18. The electronic device of claim 15, further comprising a randomizer that applies a randomized pattern change to the first transmission to create the second transmission.

19. The electronic device of claim 15, further comprising a bit interleaver that applies bit interleave to the first transmission to create the second transmission.

20. The electronic device of claim 14, wherein the relay station applies at least one of a constellation mapping change, a puncture pattern change, a randomizer pattern change, a bit interleave to the first transmission to create the second transmission.
